(19) United States
(12) Patent Application Publication
(10) Pub. No.: US 2005/0272476 A1
(43) Pub. Date: Dec. 8, 2005

(54) Free standing wireless microphone with weighted base

(76) Inventors: Robert Lee Eaton, Shakopee, MN (US); David Scott Egenberger, Eden Prarie, MN (US); Joel Peter Johnson, Minneapolis, MN (US); Edward Alan Pletsch, Lakeville, MN (US)

Correspondence Address: DAVID GEORGE JOHNSON, POST OFFICE BOX 286, AITKIN, MN, 56431, US

(21) Appl. No.: 10/862,965

(22) Filed: Jun. 7, 2004

(51) Int. Cl. H04B 1/38; H04M 1/00; H04B 1/034

(52) U.S. Cl. 455/569.1; 455/575.1; 455/557

(57) ABSTRACT

A wireless podium microphone (1) incorporates a body pack transmitter (26). The microphone (1) includes a microphone element (6) that is interconnected to a weighted base (2) by a deformable neck (3). The base (2) includes a first cavity (10) for housing electrical components associated with the operation of the microphone element (6) and a second cavity (21) in which the transmitter (25) may be securely mounted. A keyway (31) receives and constrains a button (30) that is affixed to the transmitter housing (27). Parallel guides (36, 37) are formed within the second cavity (21) and prevent lateral movement of the transmitter (26). An antenna guide (43) is mounted to the base (2) and permits the transmitter antenna (28) to be oriented to the desired antenna polarization.

### FIELD OF THE INVENTION

The present invention relates generally to the field of wireless microphones, and more particularly to an improved mounting structure for a wireless microphone transmitter.

### BACKGROUND OF THE INVENTION

A microphone is an instrument used for converting sound waves into electrical waves so as to enable them to be transmitted or amplified. Microphones have existed for more than a century, and during most of that period have been connected via a cable to the transmitting and amplifying equipment. A common application for a microphone is to amplify the sounds made by a person who is speaking at a lectern or podium in a room occupied by an audience. The microphone is typically affixed to the podium by a clamp or base, with a cable extending from the base of the microphone to the necessary amplification devices. Since the podium is often located on a stage or at the front of a classroom, the microphone cable must be routed in some fashion away from the lectern, usually across the floor, towards the rack, table or closet in which the amplifier is housed. Even when placed in a room commonly used for addressing an audience, the actual location of the podium or the seating arrangement of the audience may vary, requiring that excess cable be available to accommodate every possible situation. When a lectern is placed in a room not exclusively devoted to such a purpose, the routing and storage of the microphone cable in a safe and aesthetically pleasing manner is at best a nuisance.

Wireless microphones exist that permit a person to address an audience without the need to be tethered to a microphone cable. Such devices are interconnected to a small transmitter worn by the user, the transmitter often being referred to as a body pack or belt pack. An example of wireless microphone technology is disclosed, for example, in U.S. Pat. No. 4,555,592, entitled WIRELESS HANDS FREE CONFERENCE TELEPHONE SYSTEM, issued on Nov. 26, 1985 to Deinzer. The wireless transmitter is interconnected to a microphone which is accessible to a person while speaking. The transmitter conveys the spoken words to a nearby receiver that is interconnected to some sort of audio processing equipment that ultimately transfers the electrical signal to a loudspeaker, handset or headset.

Devices also exist which allow a person to remotely control a parent device while being located at some distance from that device. An example of such technology is disclosed in U.S. Pat. No. 6,035,350, entitled DETACHABLE I/O DEVICE WITH BUILT IN RF/IR FUNCTIONALITY TO FACILITATE REMOTE AUDIO VISUAL PRESENTATION, issued on Mar. 7, 2000 to Swamy et al. The Swamy et al. device permits a mouse tracking pad that is mounted to or docked with a portable computer to be removed from the computer. A user of the computer can then manipulate the tracking pad from a podium without the need to have the computer itself at the podium.

While the foregoing references permit the use of a wireless microphone and a computer while a person is at or near a podium, the need exists for a podium microphone which is both wireless and which may also serve as a portable body pack type of wireless microphone. Such a device would address a problem commonly encountered in a classroom or other interactive environment in which a person is addressing an audience but is also desirous of either stepping into the audience or having audience members speak to the remainder of the audience without the need for multiple microphones dedicated to each particular application.

### SUMMARY OF THE INVENTION

The present invention discloses a wireless podium microphone. The wireless podium microphone includes a free standing microphone base which is capable of accepting and securely housing a wireless bodypack transmitter. The microphone base can be configured to accept a wireless transmitter only from a specific manufacturer, a transmitter having certain physical dimensions, or any other parameter that may be appropriate.

The microphone itself includes a printed circuit board mounted in a weighted base. A light emitting diode or other suitable indicator is mounted in the base to inform the user that the microphone is active. Power for the printed circuit board as well as the light emitting diode is supplied by the bodypack transmitter via a suitable cable. The base also includes an on/off switch. Standard microphone controls addressing such issues as the microphone polar response or filtering are accessible at the bottom of the weighted base when the bodypack transmitter is not present. The rear of the weighted base includes an opening to accommodate both the cable extending from the microphone to the wireless transmitter and to permit the bodypack transmitter to extend from the transmitter some distance beyond the perimeter of the base. The antenna extends substantially horizontally from the base and thus is not readily apparent to some viewers of the wireless podium microphone. Alternatively, an antenna orientation guide is disclosed which permits the antenna to be oriented vertically as may be desired or necessary to minimize losses due to cross polarization of the transmitting and receiving antennas.

In an interactive environment, the bodypack transmitter can be readily removed and passed to an audience or panel member during, for example, a question and answer period following a lecture given at the podium. The wireless transmitter can be quickly returned to the weighted base as needed. Alternatively, additional compatible wireless microphones, of either a belt pack or hand held style, may be employed so that the transmitted audio from multiple sources, including the podium microphone, may be processed by a single receiver.

### BRIEF DESCRIPTION OF THE DRAWINGS

FIG. 1 is a perspective view of a wireless podium microphone constructed according to the principles of the present invention;

FIG. 2 is a side elevation view of the microphone depicted in FIG. 1;

FIG. 3 is pictorial representation of the control panel of the microphone depicted in FIG. 2;

FIG. 4 is a bottom plan view of the weighted base of the microphone depicted in FIG. 1;

FIG. 5 is an exploded perspective view of weighted base and wireless transmitter of the microphone depicted in FIG. 1;

FIG. 6 is a bottom plan view of the microphone depicted in FIG. 1;

FIG. 7 is an exploded perspective view of the antenna guide used in conjunction with the microphone depicted in FIG. 1; and

FIG. 8 is a perspective view of the antenna guide mounted on the weighted base depicted in FIG. 4.

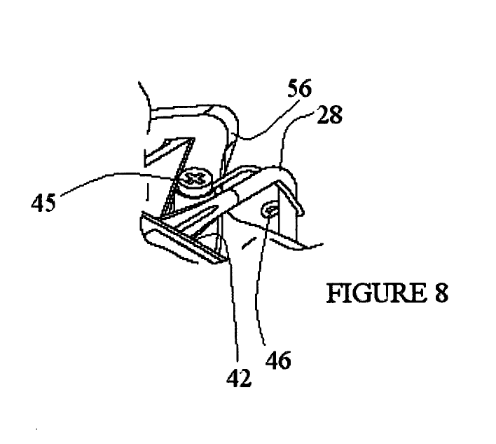

### DETAILED DESCRIPTION OF THE INVENTION

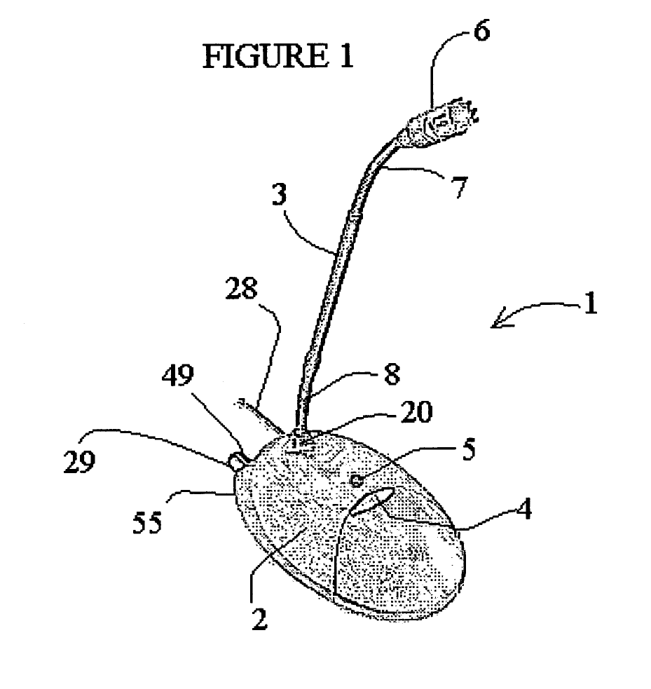

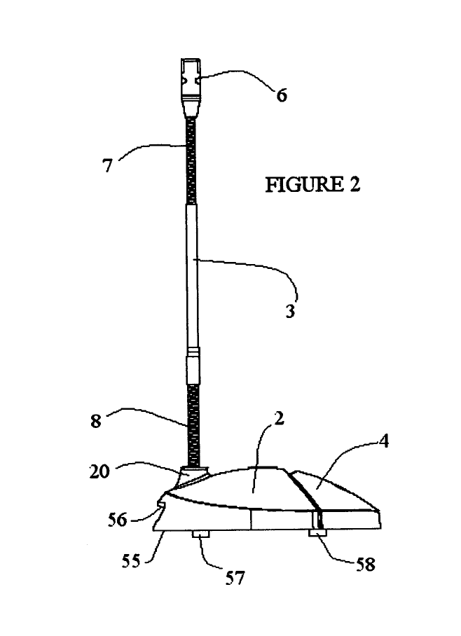

Referring to FIG. 1, the free standing microphone 1 of the present invention is seen to include a weighted base 2 which supports the microphone neck or stem 3. The base 2 is sufficiently massive to anchor the entire microphone to a surface primarily by means of gravity. The base 2 includes a operator switch 4 that is accessible to a user of the microphone 1, the switch 4 being capable of latching in either an on or off position, or placed in a push to mute mode. A light emitting diode 5 is visible to a user of the microphone 1 to indicate that the microphone is active. A dual condenser microphone element is mounted in element housing 6 at the distal end of the neck 3. Referring also to FIG. 2, the neck 3 is formed to include a plurality of deformable sections 7 and 8 which permit a user of the microphone 1 to position the element housing 6 in a desired position relative to the base 2. The neck 3 is mounted within and supported by the boss or receptacle 20 of base 2.

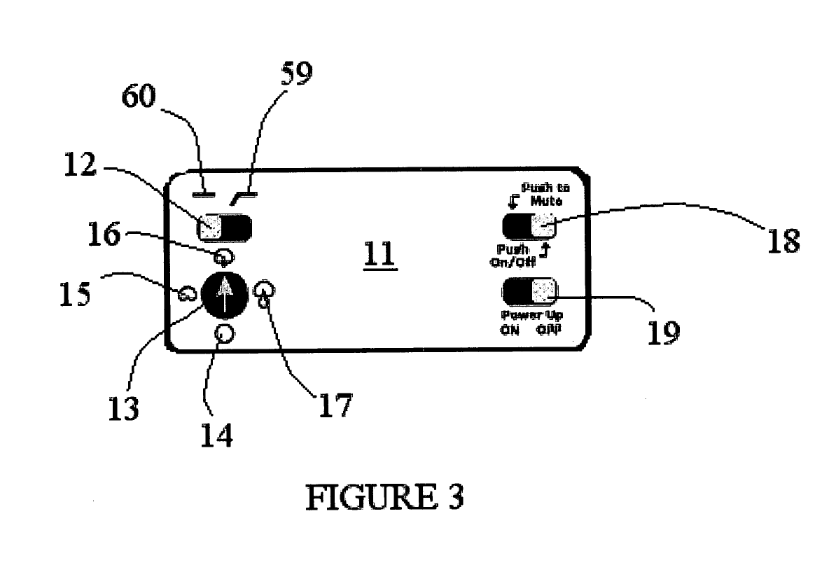

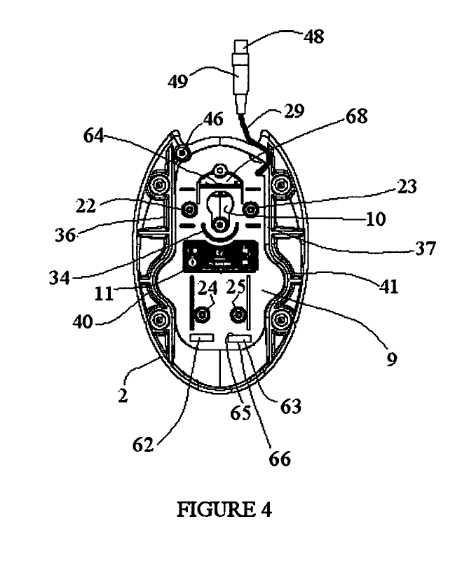

Referring also to FIG. 4, the base 2 includes a panel 9 which largely conceals or shields a first cavity 10. The panel 9 is affixed to the base 2 by means of fasteners 22, 23, 24 and 25. The first cavity 10 houses electrical components associated with operation of the microphone 1. The panel 9 supports a user interface 11 which is best seen in FIG. 3. The user interface 11 provides a filter switch 12 which permits a user to insert in position 59 or bypass in position 60 a high pass filter, the high pass filter typically providing attenuation of at least five decibels to frequencies below about one hundred hertz. The interface 11 also permits selection of the microphone pattern via pattern switch 13. The available patterns include, for example, an omnidirectional pattern 14, a cardioid pattern 15, a supercardioid pattern 16 and a hypercardioid pattern 17. The operator switch 4 may be programmed by selector switch 18 to operate in either a push to talk or push to mute mode. The electronic components associated with microphone 1 may be activated by power switch 19. The output signal of the microphone element 6, as processed by the components mounted within first cavity 10, may be connected to a conventional audio cable 48 via the TA4F cable 29, which is terminated with a TA4F connector 49.

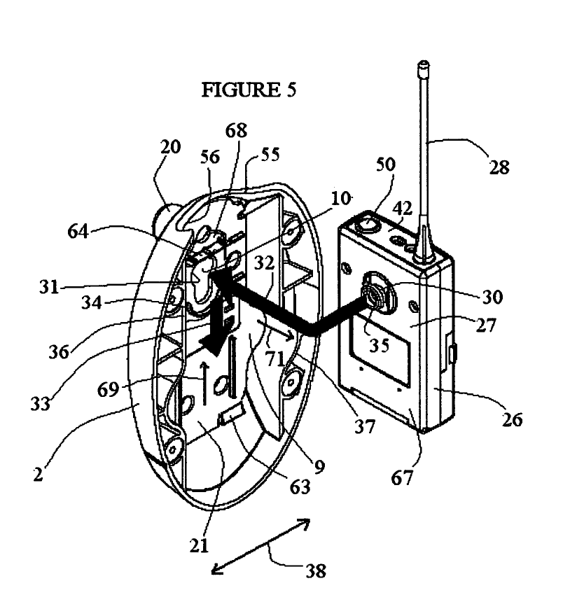

Referring also to FIG. 5, the base 2 is seen to include a second cavity 21. The first cavity 10 and the second cavity 21 are substantially separated by the panel 9. The cavity 21 is suitably dimensioned and shaped so as to snugly receive and constrain a body pack or other user wearable wireless transmitter 26. In a preferred embodiment, the cavity 21 is adapted to receive, for example, the body pack wireless transmitters having the designations RE-1, RE-2, FMR-1000, FMR-500 and S.A.F.E.-1000, all of which are manufactured by Electro-Voice, a division of the Telex Communications, Inc., 12000 Portland Avenue South, Burnsville, Minn. 55337. While the specifications of each wireless transmitter may differ, the features of the S.A.F.E-1000 are representative of this class of device. S.A.F.E is an abbreviation for Secure Audio Frequency Encryption, which is described in U.S. Pat. No. 4,293,955, entitled DIVERSITY RECEPTION SYSTEM, issued on Oct. 6, 1981 to Gehr, et al. The S.A.F.E.-1000 is part of a wireless microphone system that can include both a hand held microphone and a belt pack transmitter operating in sub bands of frequencies residing between 680 and 746 megahertz. The belt pack transmitter 26 is constructed of a cast magnesium housing 27 having dimensions of 3.75 in.×2.6 in.×0.9 in. The S.A.F.E.-1000 transmitter 26, being a typical example of this class of device, is powered by an internally mounted nine volt battery, and transmits an audio modulated radio frequency signal via a flexible, detachable antenna 28. Other body pack wireless transmitters may have substantially different characteristics without precluding compatibility with and mounting within the cavity 21.

Affixed to the belt pack housing 27 is a button or other suitable fastener 30 which is typically shaped and dimensioned so as to mate with a belt worn receptacle. In the present invention, an opening or keyway 31 is formed within the panel 9 which is dimensioned so as to securely receive the button 30. The button 30 is inserted into the keyway 31 by moving the belt pack housing 27 in the direction of arrow 32. Once the button 30 has entered into the first cavity 10 by passing through the plane defined by panel 9, the housing 27 is moved in the direction of arrow 33 until the keyway 31 prevents any further movement. When this position is reached, the perimeter 35 of the button 30 is supported by arcuate stop 34 which is formed as part of panel 9.

Further, two inclined stops 62 and 63 are formed onto the surface of panel 9, the stops being relatively lower along edge 65 and relatively higher along edge 66. Therefore, the lower region 67 of the transmitter housing 27 will be free to slide a short distance over the stops 62 and 63 before being tightly biased toward and pressed against the stops 62 and 63 as the housing 27 is moved in the direction of arrow 33. Formed adjacent to keyway 31 is a flexible keyhole 68 which is bounded by resilient ledge 64. The resilient ledge 64 is biased to remain straight and flat. Any deformation of the ledge 64 in the direction of arrow 32 caused by the presence of housing 27 pressing against the ledge 64 tends to further grip or restrain movement of the housing 27 within the cavity 21.

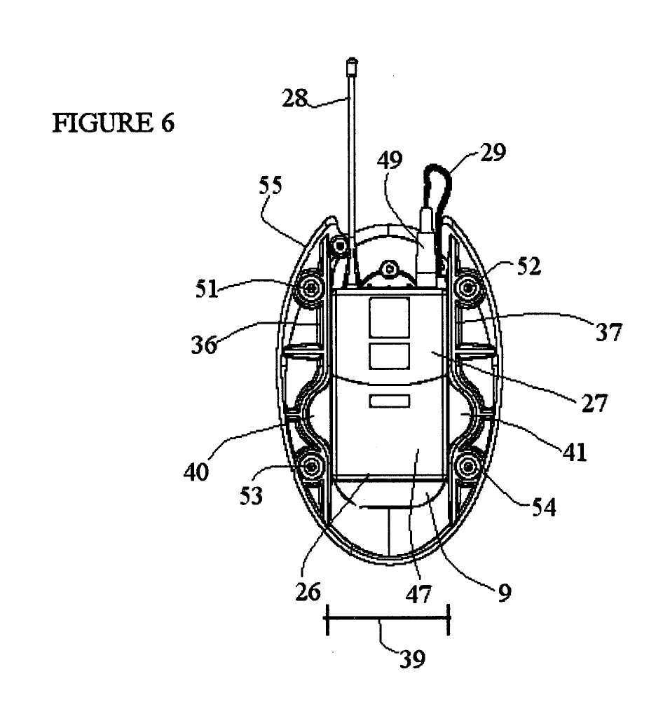

Referring also to FIG. 6, base 2 is formed to include substantially parallel guides 36 and 37, which are spaced apart a sufficient distance 39 to accommodate sliding movement of housing 27 in the direction of arrow 33, but which substantially constrain any lateral movement in the direction of arrow 38. The guides 36 and 37 will typically, but not necessarily, abut the housing 27 when the transmitter 26 is inserted into the second cavity 21. Guides 36 and 37 are formed to include arcuate or recessed perimeter regions 40 and 41, respectively, which are appropriately dimensioned to permit insertion of a human finger in order to permit insertion or removal of belt pack 26 into or from second cavity 21. When removing the belt pack 26 from cavity 21, a force is initially exerted in the direction of arrow 32 in order to overcome the biasing or gripping effect of ledge 64. The housing may then be translated in the direction of arrow 69 until the button reaches the upper end 70 of the keyway 31, at which time the housing 27 is biased in the direction of arrow 71 by the action of the flexible ledge 64, and is thus readily removed from the cavity 21.

Mounting the belt pack 26 within second cavity 21 in the manner described permits a user to gain necessary periodic access to the belt pack or to view the belt pack transmitter status. For example, the battery door 47 of transmitter 26 can be opened and closed as necessary for battery replacement. An opening 56 in the perimeter 55, beneath or near the boss 20, permits a user to access the antenna 28 and perform manipulations as required. The TA4F connector is also accessible via the opening 56. The audio output signal that is available at the TA4F connector 49 can be linked to the transmitter 26 by inserting the connector 49 into the transmitter audio input jack 50. Further, the power needed by all of the electrical components mounted in the first cavity 10 is supplied from the power supply (battery) of transmitter 26 via the TA4F connector 49.

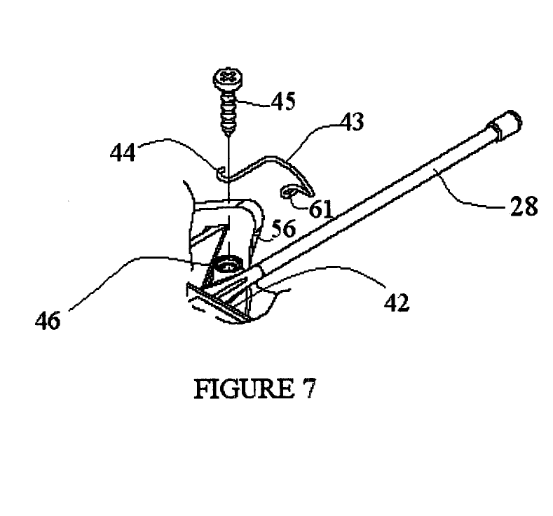

Referring to FIG. 7, the antenna 28 is seen to protrude substantially orthogonally from the top surface 42 of the transmitter 26. In most situations this results in the antennal being oriented in a substantially horizontal plane. Since the theoretical path loss between a horizontally and a vertically polarized antenna is large, and since the effective radiated power of the transmitter 26 is on the order of a few milliwatts, there will occasionally be situations where a vertical orientation of antenna 28 is necessary. In those situations requiring vertical polarization, an antenna guide 43 may be affixed to base 2.

The antenna guide 43 includes a mounting prong 44 which is adapted to receive a mounting screw 45. A mounting boss 46 is formed within base 2 and is threaded in order to accept screw 45. In this manner the guide 43 is rigidly affixed to the base 2 and may be left in place permanently or removed according to the needs of the user. The guide 43 is formed to include a guiding prong 61 through which the antenna 28 is placed. In order to securely mate the antenna 28 to guiding prong 61, the antenna must be deflected through an angle of approximately ninety degrees, resulting in a substantially vertical polarization in most situations. In those cases where a different angle of antenna deflection is desired, the antenna guide 43 may be deformed in order to achieve the desired deflection angle.

The result of the above construction is a wireless podium microphone 1 having the appearance of an elegantly designed base 2 along with the versatility of a wireless body pack transmitter 26. Although the invention has been described in conjunction with the foregoing specific embodiments, many alternatives, variations and modifications will be apparent to those having ordinary skill in the art. For example, the second cavity 21 may be more fully enclosed by the use of a cover (not shown) which can be affixed to the base 2 via mounting holes 51, 52, 53 and 54. Alternatively, the second cavity 21 may be left exposed and suitable resilient feet 57 and 58 can be placed over the mounting holes 51-54. The shape of the base 2, the positioning and orientation of the parallel guides 36 and 37, as well as the size and number of cavities 10 and 21 may all be modified as required by a specific combination of base 2 and transmitter 26. The scope of the present invention is defined by reference to the appended claims.

1. A microphone, comprising:
a base, the base being formed to include at least one cavity, the base supporting a microphone element; and
a user wearable wireless transmitter, the wireless transmitter being housed within the cavity, the wireless transmitter being interconnected to the microphone element so as to transmit a signal received from the microphone element.

2. A microphone according to claim 1, wherein the base is composed of a relatively dense material having a relatively high mass, the base thereby tending to securely anchor the microphone to a surface primarily by means of gravity.

3. A microphone according to claim 2, wherein the base further comprises at least one guide, the guide being formed within the cavity so as to constrain movement of the user wearable wireless transmitter within the cavity.

4. A microphone according to claim 3, wherein the base further comprises at least one orifice residing within the cavity, the orifice being adapted to receive a fastener affixed to the user wearable wireless transmitter, the orifice thereby constraining movement of the wireless transmitter within the cavity.

5. A microphone according to claim 4, wherein the fastener affixed to the user wearable wireless transmitter is adapted to mate with a mounting receptacle worn by a user.

6. A microphone according to claim 5, wherein the user wearable wireless transmitter includes a power supply, the power supply being interconnected to the microphone element so as to supply substantially all power required by the microphone element.

7. A microphone according to claim 6, further comprising:
an antenna, the antenna being interconnected to the user wearable wireless transmitter, the antenna extending in a first orientation beyond a perimeter region of the base; and
an antenna guide, the antenna guide being mounted to the base, the antenna guide deflecting the antenna from the first orientation to a second orientation.

8. A microphone according to claim 7, wherein the orifice residing within the cavity is formed as a keyway, the keyway permitting insertion and removal of the fastener affixed to the wireless transmitter by means of a sliding motion in a first direction.

9. A microphone according to claim 8, further comprising at least two substantially parallel guides formed within the cavity, each guide tending to constrain movement of the user wearable wireless transmitter in a second direction, the second direction being substantially orthogonal to the first direction.

10. A microphone according to claim 9, wherein at least one of the guides is formed to include an arcuate section, the arcuate section being dimensioned to accommodate manipulation of the user wearable wireless transmitter by a human finger.

11. A base for a wireless microphone assembly, comprising:
a boss formed to securely support a stem, the stem being adapted to support a microphone element;
a first cavity, the first cavity housing electrical components associated with processing of audio signals received by the microphone element; and
a second cavity, the second cavity being adapted house a user wearable wireless transmitter capable of transmitting audio signals generated by the microphone element to a receiver.

12. A base according to claim 11, wherein the second cavity comprises a pair of substantially parallel guides, the guides being spaced apart so as to substantially abut at least one surface of the user wearable transmitter when the transmitter is housed within the second cavity.

13. A base according to claim 12, wherein at least one of the substantially parallel guides is formed to include at least one recessed region, the recessed region being dimensioned so as to accommodate at least a portion of a human finger whenever removal of the user wearable transmitter from the second cavity is desired.

14. A base according to claim 13, wherein the base comprises an opening within a perimeter of the base, the opening permitting user access to portions of the user wearable transmitter when the wearable transmitter is housed within the second cavity.

15. A base according to claim 14, further comprising a deformable antenna guide, the antenna guide engaging an antenna extending from the user wearable transmitter and permitting user adjustment of antenna orientation with respect to the base.

16. A base according to claim 15, further comprising:
a panel, the panel residing between the first and second cavities and defining a boundary between the first and second cavities; and
a user interface, the user interface being mounted to the panel, the user interface permitting adjustment of signal processing characteristics of audio signals generated by the microphone element.

17. A base according to claim 16, further comprising a user detachable cable, the cable being interconnectable to a jack on the user wearable transmitter, thereby permitting the transmitter to broadcast processed audio signals generated by the microphone element.

18. A base according to claim 17, wherein the microphone element obtains substantially all required electrical power from a power supply residing within the user wearable wireless transmitter, the electrical power being obtained via the detachable cable.

19. A method for creating a wireless podium microphone, comprising the steps of:
forming a weighted base having at least one internal cavity;
mounting a deformable stem to the weighted base;
affixing a microphone element to the deformable stem;
housing audio signal processing components within the base;
interconnecting the microphone element to the audio signal processing components;
mounting a user wearable wireless transmitter within the internal cavity of the base; and
interconnecting the audio signal processing components to the user wearable wireless transmitter, thereby enabling the wireless transmitter to broadcast processed audio signal originating from the microphone element.

20. The method of claim 19, further comprising the steps of:
mounting an antenna guide on the base; and
routing an antenna associated with the wireless transmitter through the antenna guide so as to achieve a desired antenna orientation.
